(19) United States
(12) Patent Application Publication
(10) Pub. No.: US 2021/0332690 A1
(43) Pub. Date: Oct. 28, 2021

(54) METHOD AND SYSTEM OF COMBINED SUPPORT FOR A WELL DRILLING PROCESS

(71) Applicant: Obshchestvo s ogranichennoj otvetstvennost'yu "Geonavigacionnye tekhnologii", Moscow (RU)

(72) Inventors: Sergej Igorevich Stishenko, Saint-Petersburg (RU); Yurij Anatolevich Petrakov, Moscow (RU); Aleksej Evgenevich Sobolev, Moscow (RU)

(21) Appl. No.: 16/627,926

(22) PCT Filed: Sep. 18, 2019
(86) PCT No.: PCT/RU2019/000645

§ 371 Date: Dec. 31, 2019

(30) Foreign Application Priority Data
Oct. 16, 2018 (RU) 2018136493

(51) Int. Cl. E21B 44/02; G01V 99/00

(52) U.S. Cl. CPC E21B 44/02; E21B 7/04; G01V 99/005

(57) ABSTRACT

A method of combined tracking of the well drilling process includes the following steps: obtaining input data of the well under development, including inclinometer data, data from a well geophysical survey and core data; obtaining logging data of a key well; generating a combined model reflecting the rock characteristics and predicting the position of the well bore under development; determining the drilling trajectory of the well under development; calculating the synthetic log curve on the basis of the combined model and the design drilling trajectory of the well under development; creating a preliminary well bore stability model on the basis of the trajectory of the well under development and the synthetic curve; determining the design trajectory on the basis of the well bore stability model; obtaining parameters during the process of drilling the well under development which characterize the inclinometry, the (well geophysical survey) data and drilling parameters; updating the combined model and monitoring the drilling process of the well under development.

### FIELD

The claimed solution relates to a method and system for computer-based processing of specialized data used to steer well drilling.

### DESCRIPTION OF THE RELATED ART

The success of constructing oil and gas wells is determined by both short-term parameters, that can be assessed while drilling, and long-term indicators that emerge during well operation. Today, steering of well drilling involves a wide range of engineering disciplines.

The tasks of geologists and geosteering experts include delaying flooding, sand failures, and well overhauls as much as possible, as well as making the geosteering process safe, fast and efficient. In order to fulfil these tasks, it is necessary to accurately determine the optimum position of the wellbore in the stratum. Since a well is a 3D object, one has to work with a coordinate system and accompanying concepts. Coordinates have to be accompanied with various sorts of depths, as in most cases, a single Z coordinate is not enough. Since a well has to be drilled within a specific interval of a stratum, three more factors have to be taken into account, such as stratum geometry (i.e. the position of the target interval), well geometry (i.e. how the well trajectory has to be changed for the well to hit the interval), and stratum properties (calculated with devices that allow to understand the well's current position relative to the target interval). Geomechanical steering of drilling involves monitoring of drilling parameters and adjusting the actions of the drilling team, if necessary.

Current economic realities of the carbohydrate market require oil-and-gas companies to constantly optimize their activities and increase their efficiency. Well construction is the costliest part of drilling company operations, while, at the same time, most lending to optimization. According to various estimates, North American oil-and-gas companies spend up to $30 bn every year on issues concerning drilling. Wellbore instability issues account for the major part of these expenses (up to 60%).

Most severe disruptions in the natural state of rocks that are caused by drilling may result in intense showings of oil, gas and water in wells and even outbursts. Tackling these issues caused by selection of a wrong flush fluid (i.e. flowing pressure in the well is not offset by stratum pressure) takes much time and effort, as well as entail huge costs and, as often as not, result in a lost well.

However, the most common drilling issue is wellbore instability, also caused by selection of a wrong mud and a high stress concentration that exceeds the rock strength. Most commonly, wellbore instability causes sludge build-ups, well ovalization, requiring longer flushing, while leaving less time for actual drilling (quite often, well normalization efforts take much more time than drilling itself). Also, geophysical survey of the well will be distorted by a deteriorating wellbore. In other situations, especially when drilling inclined or horizontal wells, cavings may cause well blockages, differential bottom-hole assembly (BHA) sticking, even loss of an open wellbore and equipment inside it, requiring side tracking. Well blockages, in turn, may cause hydropercussion, fracturing cracks, complete or partial spilling of mud into the stratum. The accompanying pressure drop in the well may create a hazard of formation fluid showings and further cavings. However, carbohydrate-based muds are expensive, as well as may cause critical ecological damage if spilled in offshore fields.

Also, there is an obvious trend that the share of difficult-to-reach oil and gas deposits is steadily increasing, while the number of easy-to-reach oil and gas deposits is constantly reducing. To address this challenge, it is proposed to make all the operations automated and real-time based, as well as to use teams of multiple experts in such fields as geology, petrophysics, geomechanics, drilling engineering, and mud experts.

When a large team is assembled, comprising various specialists, it becomes obvious that there is no single software environment that would, first, provide a convenient toolkit for all drilling participants, and, second, update models for all branches in real time. Such software solution also has to be able to process and design complex interdisciplinary models.

The closest prior art is a method disclosed in the patent RU 2,560,462 by Halliburton Energy Services, Inc. (US), made public on Aug. 20, 2015. The known method is used for determining the trajectory of a well made by the drilling shaft, the method comprising the following steps: obtaining data that describe one or more drilling parameters between at least two deviation survey points; averaging the obtained data by predefined incremental steps between the at least two deviation survey points; based on at least the averaged data, calculating projected reactions of the drilling shaft for each of the predefined incremental steps; based on at least the projected reactions of the drilling shaft, determining the changes in the inclination angles and azimuths for each of the predefined incremental steps; based on at least the changes in the inclination angles and azimuths, generating a projected well trajectory; comparing the projected well trajectory with the measured well trajectory; and, if the comparison results are acceptable, based on at least the changes in the inclination angles and azimuths for each of the predefined incremental steps, determining a probable position of the well.

This known solution does not use the approach involving measurement of synthesized logging traces and building of a hybrid model with them, in order to determine the optimum trajectory for accurate drilling within the target interval, which is generated using both geomechanical and geosteering models of drilling.

### SUMMARY

The problem to be solved is to provide a combined model for steering well drilling that would combine geomechanical and geosteering analyses to provide a comprehensive solution for steering the process of well drilling and for maintaining the wellbore stability.

The objective of this invention is to improve the accuracy of modelling of the process of well drilling within a target interval, while maintaining the wellbore stability.

The claimed method for combined steering of well drilling comprises the following steps:
obtaining input data for a borehole that include at least deviation survey data, GIS data, and core sample data;
obtaining logging data for at least one test (reference) well;
based on the input data and the logging data for at least one test (reference) well, generating a combined model that reflects rock characteristics and wellbore position projection;
based on the logging data for at least one test (reference) well, determining at least one target trajectory of well drilling;
based on the combined model and the at least one target trajectory of well drilling, calculating at least one synthesized logging trace;
based on the at least one target trajectory of well drilling and the at least one synthesized logging trace, creating a preliminary model of wellbore stability;
based on the preliminary model of wellbore stability, determining a target trajectory that would provide maximum drilling penetration within the target interval, and wellbore stability;
while drilling a well, obtaining parameters that describe its deviation, GIS, and drilling characteristics; and
updating the combined model and steering the process of well drilling using this updated combined model.

In an exemplary embodiment of this method, the wellbore stability is recalculated during the process of well drilling, based on the drilling parameters obtained.

In another exemplary embodiment of this method, the information about cracks in rock strata can be used.

In yet another exemplary embodiment of this method, the position of a well within the target stratum is checked when updating the combined geosteering model.

In yet another exemplary embodiment of this method, the test well is selected based on interwell correlation and the structural map of the upper boundary of the target stratum.

In yet another exemplary embodiment of this method, the preliminary model of the wellbore stability is based on the parameters of stratum pressure, fracking gradient, rock mechanical properties and stresses.

A system for combined steering of drilling comprises at least one CPU and at least one memory device that stores machine-readable instructions, which can be executed by the CPU to implement the method mentioned above.

A method of combined support for a well drilling process, comprising the steps of: receiving input data of the well which is being developed, including at least inclinometry data, well logging data and core data;

obtaining logging data of at least one reference well;
forming, on a basis of the mentioned input data and the logging data of at least one reference well, a combined model displaying rock characteristics and predicting a position of the well which is being developed;
determining at least one planned trajectory of a direction of drilling the well which is being developed; the trajectory being based on the logging data of at least one reference well;
calculating at least one synthetic logging curve based on the aforementioned combined model and at least one planned trajectory of the well which is being developed;
performing a construction of a preliminary model of a stability of a wellbore, based on at least one trajectory of the well which is being developed and calculated at least one synthetic curve;
determining, based on the preliminary model of the wellbore stability, an updated planned trajectory that ensures maximum of a well penetration within a target interval and the wellbore stability;
receiving parameters during a drilling of the well which is being developed; the parameters related to the inclinometry, logging data and the drilling;
updating the mentioned combined model and controlling a process of the well drilling based on the updated combined model.

In yet another exemplary embodiment during the process of the well drilling, the stability of the wellbore is recalculated based on the obtained drilling parameters.

In yet another exemplary embodiment the method additionally uses information about a presence of cracks in a reservoir.

In yet another exemplary embodiment when updating the combined model, a position of the developed well within a target formation is checked.

In yet another exemplary embodiment a selection of the reference well is carried out due to a cross-hole correlation and structural maps on a roof of a target formation.

In yet another exemplary embodiment the preliminary model of the wellbore stability is based on parameters of a reservoir pressure, a hydraulic fracturing gradient, mechanical properties of a rock and stresses.

### BRIEF DESCRIPTION OF THE ATTACHED FIGURES

FIG. 1 shows a well depth diagram.

FIG. 2 shows a stratum dip diagram.

FIG. 3 shows an exemplary bottom-hole assembly (BHA).

FIG. 4 shows profile length and well horizontal displacement.

FIG. 5 illustrates geological uncertainties.

FIG. 6 illustrates an example of uncertainty of measurements in a horizontal well.

FIG. 7 illustrates an exemplary approach of separated steering of well construction.

FIG. 8 shows an overall scheme of combined steering of well drilling.

FIG. 9 shows a flowchart of the claimed method.

FIG. 10 illustrates exemplary calculation of stratum pressure.

FIG. 11 illustrates exemplary selection of test wells.

FIGS. 12 and 13 illustrate exemplary creation of a combined model for geological drilling.

FIG. 14 illustrates exemplary plotting of a synthesized logging trace.

FIGS. 15 and 16 illustrate exemplary comparison of synthesized and actual loggings.

FIG. 17 shows a diagram of determining of mechanical properties and stresses.

FIG. 18 shows an overall view of the claimed system.

### DETAILED DESCRIPTION OF THE PREFERRED EMBODIMENTS

The present disclosure contains the following terminology, complete with abbreviations and definitions:

Well mouth is the starting point for measuring the depth of a well (usually, from the rotary table).

Mouth coordinates is the spatial (lateral) location of the hole mouth, in a specified coordinate system (e.g. X/Y, latitude/longitude, etc.).

Coordinate grid is a coordinate system used to locate a point in space.

Altitude is the height of the hole mouth above the Mean Sea Level (an absolute zero point).

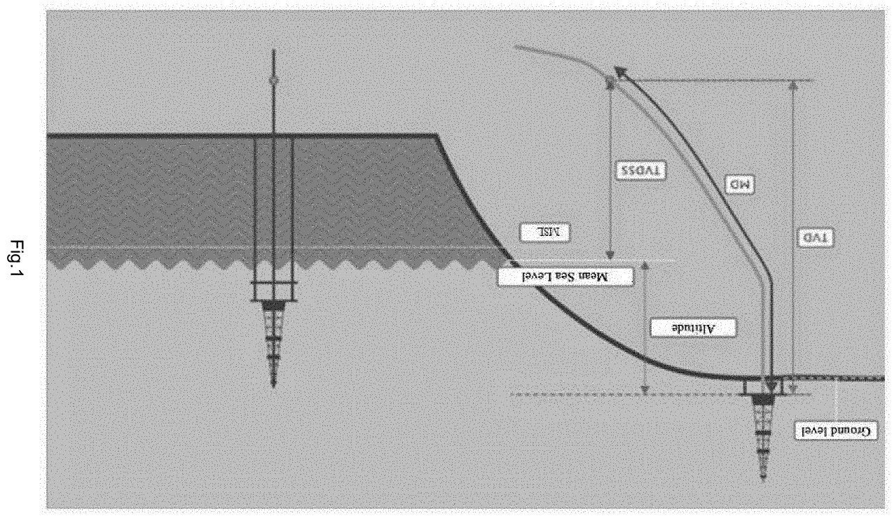

Measured depth—the length of the well trajectory curve at a certain point of measurement (see FIG. 1).

True Vertical Depth is the vertical depth measured from the rotary table.

True Vertical Depth Sub-Sea is absolute depth measured from the Mean Sea Level.

Total depth is the depth of the well bottom.

Mean Sea Level is the initial position of the free surface of the World ocean, a standard point for measuring absolute height of land objects and absolute depth of seas.

Ground level is the height of earth surface measured from the Mean Sea Level.

Stratification is the occurrence of sedimentary rocks in the Earth's crust in the form of strata, layers, and interlayers.

Surface (horizon) is the boundary that divides strata, showing their structural geometries.

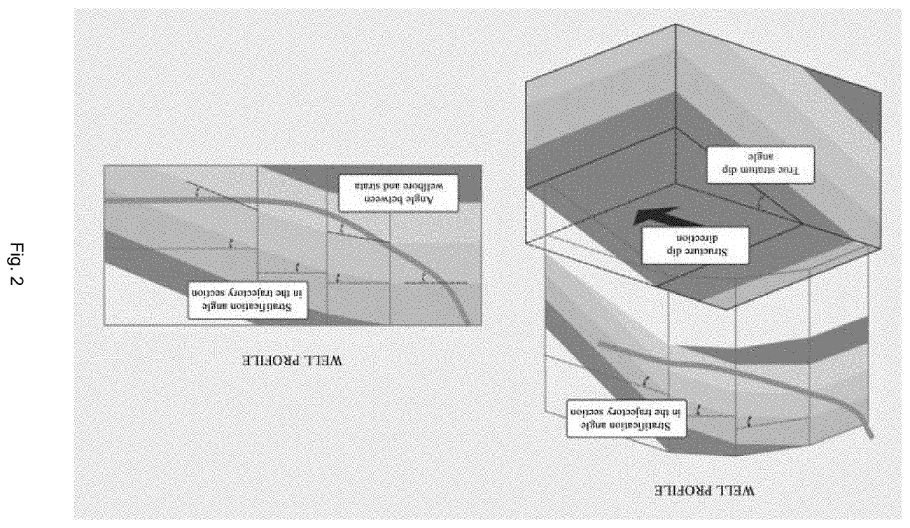

(True) dip of a stratum/its structure is the angle between the stratum surface and horizontal plane, i.e. between the line and trend of dip (see FIG. 2).

Apparent (relative) dip is the stratum inclination relative to the cross section of the well trajectory.

Angle between the well and stratum structure dip is the angle between the well axis and stratum dip in the cross-section of the trajectory.

Stratum dip azimuth is the angle between the meridian of the monitoring point and the line of stratum dip.

Structural map is a map showing the surface of the upper or lower boundary of a given stratum or horizon.

True Vertical Thickness is the stratum thickness measured vertically between its upper and lower boundaries.

Well drilling is a process of constructing a well by destroying rocks with drilling equipment (i.e. drilling shaft).

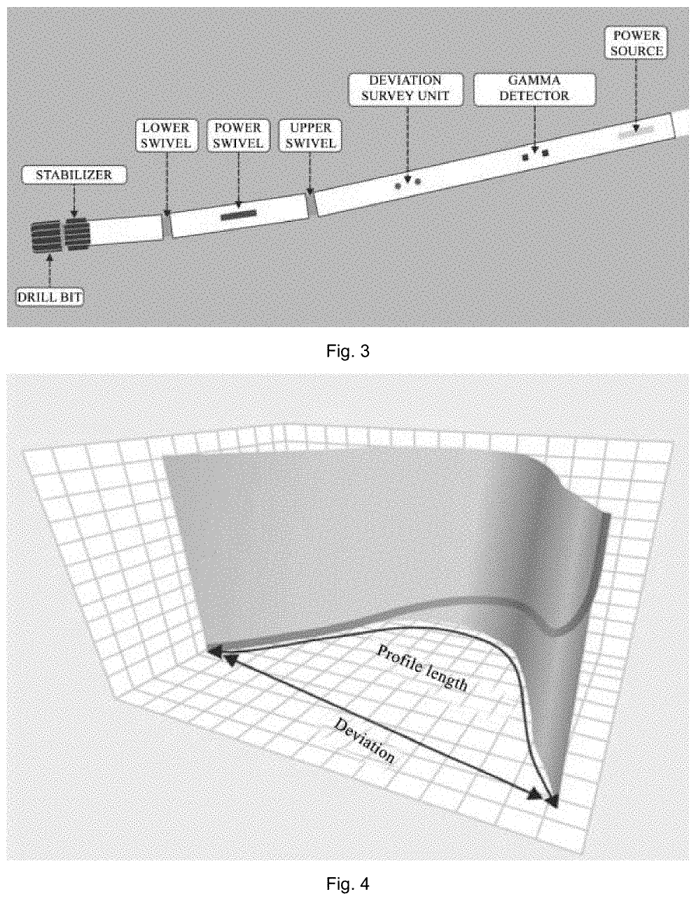

Bottom-hole assembly (BHA) is the bottom part of the drilling shaft between the bit and drill pipes. The composition of the assembly may vary, depending on the task (side tracking, vertical drilling, drift angle buildup, correction work). Conventionally, a BHA (see FIG. 3) comprises a bit, a bottomhole motor, stabilizers, MWD devices and well trajectory steering devices.

Measurements While Drilling (MWD) include determining the current inclination angle and magnetic bearing, as well as measuring vibration levels, bit load, and annular pressure. Also, WMD devices perform data exchange with the surface and power up LWD devices.

Logging While Drilling (LWD) includes determining the geophysical characteristics of a given stratum. Such measurements may employ a wide range of methods, i.e. electromagnetic logging, density logging, acoustic logging, nuclear magnetic logging, seismic logging, and neutron logging.

Well trajectory steering helps to drill the well in a given direction, using the readings from MWD and LWD devices.

Bit projection is the projection of deviation data on the current well bottom, based on actual measurements and main BHA parameters.

Telemeasuring (telemetry) apparatus is a device for measuring inclination and azimuth angles while drilling and pass the data from the bottom hole to the surface.

Modern telemetry apparatuses also allow to measure many different parameters, such as bit vibration, gamma logging, induction logging, mud resistivity logging, annular pressure, as well as provide power for other logging devices while drilling.

Deviation survey is a method for monitoring the spatial position of the well axis. The well vertical deviation (inclination angle) and magnetic bearing of the well axis projection on a horizontal plane are measured. The measurements are made by means of electric, photographic, and gyroscopic inclinometers. Other parameters that define the well spatial trajectory are calculated based on the three measurements: measured depth, inclination angle, and magnetic bearing. Deviation survey data are used to drill the well in a predetermined direction, to determine actual depth of geological object occurrence, to plot maps and sections, when logging and drilling materials are used.

Inclination measurements taken in a certain point describe the spatial location parameters of a well (its inclination angle and magnetic bearing at a given measured depth).

Spatial deviation is a value reflecting the extent (or rate) of wellbore deviation from its original direction. This deviation is calculated as a ratio between the deviation angle increment and the distance between measurement points along the well axis.

Dog leg is the extent of vertical deviation of a wellbore.

Tan is the extent of horizontal deviation of a wellbore.

Horizontal displacement of the well is the distance between the well mouth and the measurement point on the horizontal plane.

East/west displacement of the well is the distance between the well mouth and the measurement point on the east/west-oriented plane.

North/south displacement of the well is the distance between the well mouth and the measurement point on the north/south-oriented plane.

Total displacement is the distance between the well mouth and the current well bottom on the horizontal plane.

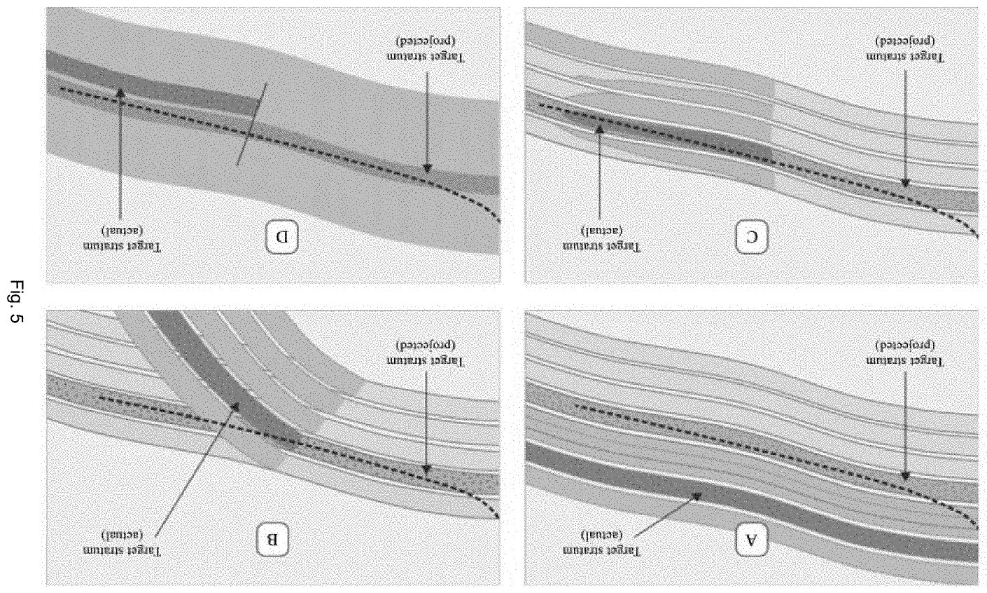

Well profile length (displacement along the wellbore trajectory) is the length of the wellbore trajectory curve from the well mouth to the measurement point on the horizontal plane (see FIG. 4).

Vertical cut (vertical section) is the distance between the well mouth and the measurement point on the vertical plane with the vertical projection. This value may vary according to the azimuth of the vertical projection.

Wellbore azimuth (azimuth angle) is the angle between the well axis projection on the horizontal plane and a given direction (e.g. magnetic north or true north).

Inclination angle is the angle between the well axis and vertical.

Geosteering (geological steering, well placement) is controlled changing of wellbore position in the stratum, based on the analysis of geological, geophysical, and deviation survey data collected while drilling. Geosteering starts before the target interval is opened up. All preparations for steering have to be finished while drilling a hold section, which is located above the horizon and is mainly used to maintain successful geosteering in the target interval. Usually, a hold section is an inclined section. After leaving the hold section, the next important task is to “settle” the well onto the upper boundary of the target interval (of the stratum), which is the stratum (or a part thereof) that has been designated for construction of a horizontal section or a horizontal auxiliary well in order to maximize the output of the well.

In order to accurately determine the trajectory of a horizontal section or a horizontal auxiliary well, geological targets have to be used, i.e. 3D objects (points in a 3D space, or parallelepipeds) through which the trajectory for the optimum position of the horizontal wellbore within the target interval has to pass.

Next, Tᵢ points are determined:

Tᵢ is the point of intersection between the wellbore and the upper boundary of the target interval. T₂ is the first point of the horizontal part of the trajectory, where the inclination angle is 90 degrees. If a gentle trajectory is used, then T₂ is described as a point, where the wellbore deviation has no major fluctuations. T₃ is the projected Total Depth (TD) of the well. This is the final point of the drilling.

Stress is force applied to a unit area. Compressive stress is positive. Each plane is affected by three types of stress: a normal stress and two shearing stresses. Rock resistance to load is determined by the sum of stresses in the rock matrix and pore pressure.

Deformation is the alteration of shape and size of a body caused by external forces. Deformations can also be normal and shearing.

Hooke's law is a fundamental law that describes quantitative relations between deformation and the load applied.

Rock elasticity (Young's modulus, or stiffness) is the ratio between the load applied and axial deformation. Poisson's ratio is the ratio between relative transverse compression and relative longitudinal extension. Biot coefficient describes how effectively fluid pressure resists an applied load. There are dynamic and static modules. During logging, acoustic waves create short and low-amplitude deformations in the rock. Wave equations can be used to obtain dynamic medium modules. Static modules are obtained by testing core samples in a lab by slowly loading the samples until they are crushed. Static modules provide better estimates of rock behavior.

Strength is the maximum load that the rock can sustain.

Failure is a situation when the material can't perform its engineering functions because its elasticity limit has been reached. Elasticity limit represents maximum load, beyond which the rock undergoes plastic deformations, such as microcracks, grain packing distortions, or shifts.

Mohr-Coulomb failure criterion represents estimated shearing stress that the rock can sustain.

Pore pressure is the pressure exerted by formation fluids on rocks that contain them (for permeable rocks). Formation pressure in clays (with very small pores) is fluid pressure in a permeable interval that is in long-run equilibrium with clays.

Hydrostatic pressure is the pressure that is exerted by a fluid at equilibrium.

Anomalous rock pressure is rock pressure that exceeds the normal hydrostatic pressure for the given depth.

Caving is a failure of rocks because of inadequate specific weight of mud in the well. Rock mechanics allow to calculate when inrushes or cavings may start, but the actual process of rock parts falling from the sides of a wellbore is triggered by a number of drilling parameters, such as pump productivity, pressure fluctuation dynamics in the well, mechanical impacts by drilling tools during drilling and wiper trips, etc.

Absorption is mud leaking into the stratum because well pressure exceeds minimum horizontal stress. Uncontrollable absorption of flush fluid may cause complete loss of circulation. Absorption may also happen in fractured reservoirs.

During construction of a horizontal well or a horizontal auxiliary well, the following problems arise. When trying to position a wellbore properly, the biggest problems are caused geological uncertainties and measurement errors.

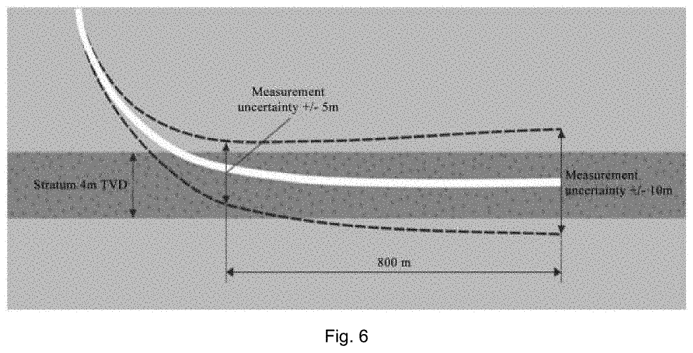

Geological uncertainties include:
uncertainty of the horizon structure depth (see FIG. 5, pos. A). To determine the structure, seismic data are used first that have resolution within a range of dozens of meters. Even if there are already drilled wells, it is impossible to say with absolute certainty where a structure should occur, since there are always depth variations.
uncertainty of structural stratum dip (see FIG. 5, pos. B).
stratigraphic uncertainty (see FIG. 5, pos. C).
   Stratigraphic uncertainty is caused by the fact that strata are rarely stratigraphically consistent. If this is ignored, the well may easily go outside the target interval while drilling.
presence of faults, lenticels, pinchouts (see FIG. 5, pos. D);
lateral or vertical alterations of facies;
current position of contacts;
geological inconsistencies that can't be predicted based on seismic data.

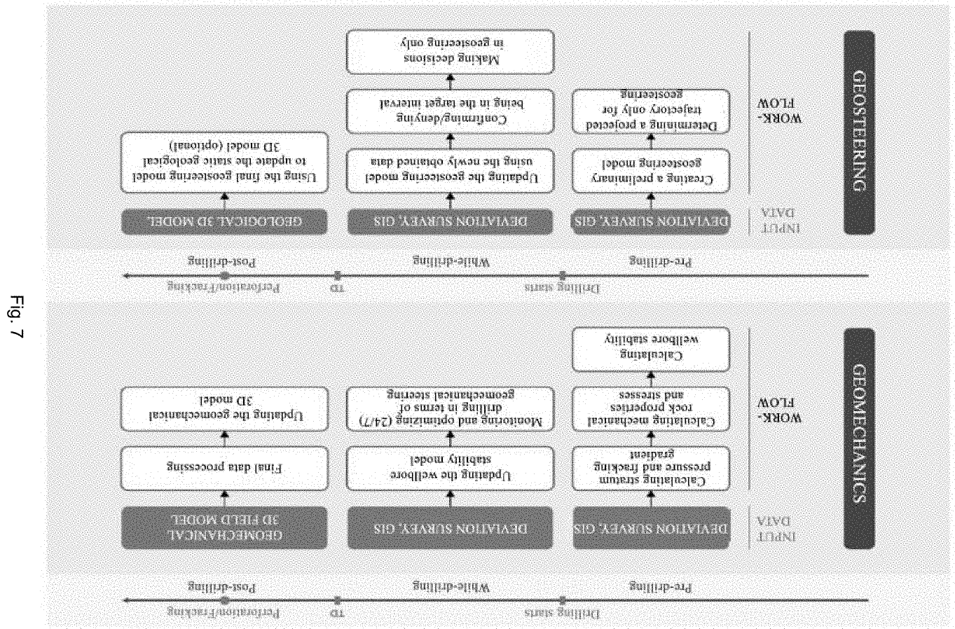

Measurement errors may arise when measuring depth, carrying out deviation survey, or logging. Such errors may arise because of a variety of reasons: errors in drill-pipe measurement, drilling shaft tension caused be gravitation, heat deformations, measurement limitations of inclinometers, inaccurate centering of the instruments. Therefore, a situation may arise, when measurement uncertainty exceeds thickness of the stratum to be drilled (see FIG. 6).

The combined impact of geological and measurement uncertainties results in unsuccessful as-designed drilling. Each meter of a horizontal section outside the target interval results in investment losses. Besides, drilling outside the reservoir may mean drilling in formations with different geomechanical properties that may cause the risks to spike. It is difficult to overestimate geosteering. According to some estimates, each meter of a horizontal section outside the reservoir results in losing up to 30,000 tons of carbohydrates. A half-meter-thick mudded-off interlayer causes no problems in a vertical well, but may run indefinitely when drilling a horizontal section parallel to it. On the other hand, successful geosteering may bring economic benefits amounting to hundreds of millions of dollars (see, for example, the case of StatoilHydro, Troll field [1]).

Based on the above, the objective of the present invention is to provide a method that combines the geosteering model with the geomechanical model into a single approach that would allow to solve the problems of geological steering of well drilling and the problems of stabilizing the wellbore simultaneously. A combined model has to be capable of operating in real time. Every time the borehole trajectory is changed by geosteering, the drilling slot in the geomechanical component of the model has to be recalculated.

Described below is the conventional workflow of using geomechanics and geosteering in well drilling. In fact, these are two independent procedures that have little in common, although they use almost the same input.

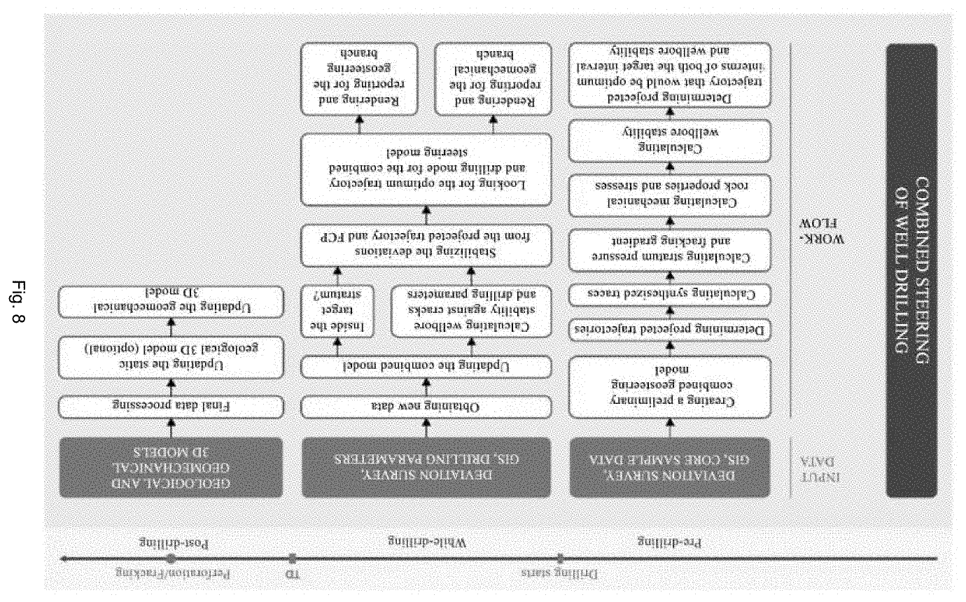

Dividing the well drilling process into three main stages (pre-drilling, while-drilling, and post-drilling), geosteering is used in each of these stages. The workflow is schematically illustrated by FIG. 7. At the pre-drilling stage, the main result is to draft a preliminary geosteering model, based on the data that have been obtained in the already drilled test wells.

After drilling has started, the main task is to prevent it from going outside the target interval. Decisions are made strictly within the geosteering branch, without considering well trajectory optimization in the terms of maximizing the drilling, reducing LEL and risks of wellbore instability.

Described below it the process of geomechanical steering of drilling. This process also starts at the pre-drilling stage, as described above, and involves audit of data and pre-drilling geomechanical 1D modelling based on the test well data. After drilling has started, the main task is to provide 24-hour geomechanical steering of drilling in order to minimize formation damage and improve the wellbore quality. This stage involves monitoring and analysis mechanical drilling parameters, real-time updates of pore pressure model, hydraulic fracturing pressure gradient model, and wellbore stability model. After drilling has finished, the geomechanical 3D model of the field is updated using the data obtained when drilling a new well.

It is obvious that conventional approach based on separation of geosteering while drilling and isolated geomechanical steering has a number of drawbacks.

First, without an interaction between branches, the overall efficiency of well drilling is significantly deteriorated. For instance, it may lead to a situation when the projected drilling penetration has been reached, but the well has been drilled outside the target timeframe. Due to segregated branch-specific approaches to steering, situations may arise, when optimal solutions in the geosteering branch contradict those in the geomechanics branch.

Another drawback of segregating the branches is that they cover the process of well drilling only partially. At the initial (pre-drilling) stage, geosteering skills and expertise are rarely used, and at the final stage, there is no profound input from geomechanics experts.

In order to remedy the situation, it is necessary to change the approach to steering of drilling and make it a complex engineering and technical process that involves continuous synchronization of geomechanics and geosteering.

There is a need to analyze geomechanical and geosteering data within a combined model. By creating such a model, it is possible to achieve the following:
allow the engineers who use such combined approach to optimize the drilling process in terms of both maximization of penetration within the target interval and minimization of LEL, lower accident rates, faster drilling;
implement early warning systems that would alert the personnel when entering unfavorable drilling environment, e.g. moving from a consolidated sandstone reservoir into an area with reduced wellbore stability.

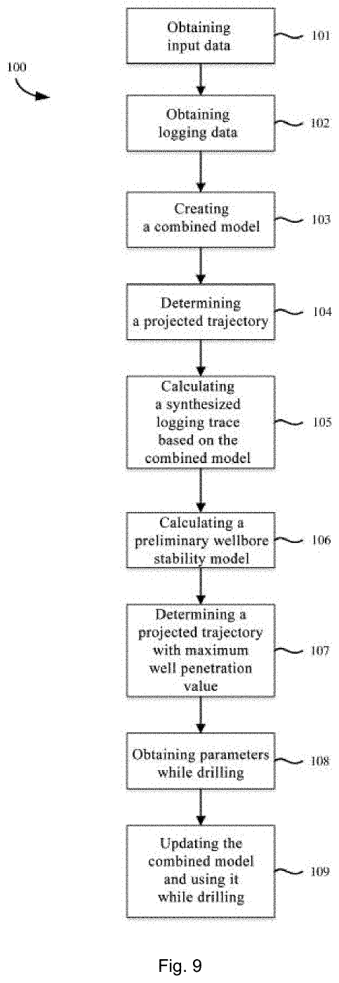

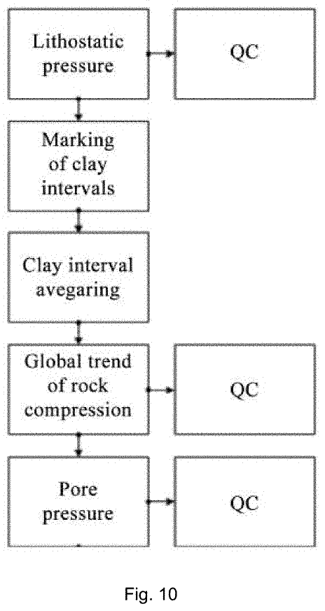

The following detailed description of the claimed solution contains references to FIG. 8 and FIG. 9. FIG. 8 is a general conceptual diagram of the claimed method.

When combined steering of well drilling in real time is employed, one of the processes that require regular processing of continuously updated data and on-the-spot monitoring by the experts involved is verification and analysis of geological and geophysical data obtained while drilling (LWD), as well as its petrophysical interpretation for further use in geosteering. One can easily see that both the geomechanics branch and geosteering branch use practically the same data as input, except for core sample data.

FIG. 9 shows that in the first step (101) the minimum input required for carrying out the claimed method includes deviation survey data, GIS data, and core sample data.

The main link between the geomechanical and geosteering models is made through a common set of input data and projected trajectory data. Any changes in the projected trajectory triggers cascading changes in the geosteering model (changes of wellbore position in relation to reference interlayers), as well as repeat calculation of the components of the geomechanical model, i.e. pore pressure model, hydraulic fracturing pressure gradient model, and wellbore stability model.

Below is a detailed description of connections between all components of the geomechanical model and projected trajectory of the future well.

First, a more detailed description of geomechanical steering of drilling. In fact, in order to obtain the wellbore stability model, the following steps have to be performed:
Calculating lithostatic pressure and stratum pressure;
Calculating mechanical properties of the stratum; and
Calculating stratum and near-wellbore stresses.

It is possible to estimate stratum pressure based on logging data, since clay porousness is known to decrease exponentially with depth. In an ideal instance of the hydrostatic gradient of the pore fluid pressure, there will be a normal trend of clay thickness decreasing with depth. In case porousness values deviate from the normal trend, it is logical to surmise that stratum pressure deviates from its normal.

This method works for clays only, since sandstones/limestones don't demonstrate the same regularities in the decrease of their porousness with depth. This is the main foundation of the methodology used to calculate the porousness decrease trend. All calculations have to be made only for pure clay intervals.

There are several quasi-empirical patterns for comparing logging values with pore pressure values. These patterns have to be “adjusted” for each individual field by modifying their coefficients.

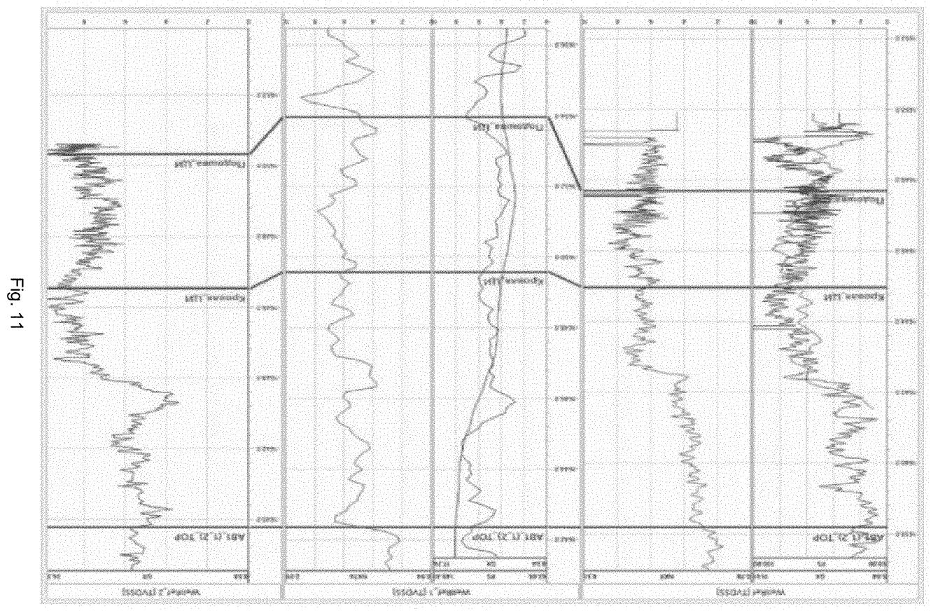

To provide proper correlations between pressure prediction models for different wells, there is always a need to compare plotted traces from different wells. This is the quality control procedure that has to be applied to every major calculation step. FIG. 10 shows an exemplary scheme for calculating stratum pressure.

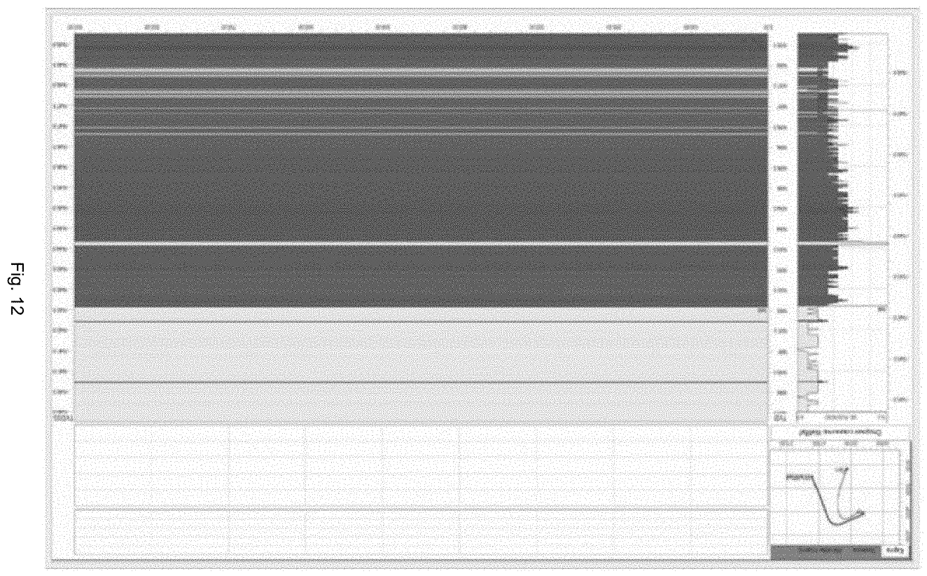

Then, in step (102) one or more test wells are selected for drafting an initial geological drilling model. A test well may be either vertical or inclined. It is selected from already drilled neighboring wells, stratum properties of which are similar to those in the projected drilling area. A pilot well for a horizontal well may also serve as a test well. Test well logging data are used to determine geophysical properties of each stratum interlayer and to predict those properties along the entire length of the horizontal well. The test well may be selected based on interwell correlation and the structural map of the upper boundary of the target stratum. A correlation diagram (see e.g. FIG. 11) allows to assess stratum strengths and their lateral homogeneity for the projected well and potential test wells.

Locations of main geological markers in the wells that surround the future (actual) well allow to approximate the expected changes in key interlayer thicknesses in the actual well. To get a complete picture, it is necessary to carry out a map analysis. The structural surface of the upper boundary of a stratum is plotted based on stratum markings in neighboring wells using the seismic survey trend. Thus, the results of seismic survey data interpretation is combined with those of logging data interpretation. From a structural map, it is possible to derive information regarding stratum dip or stratum buildup in the direction of projected drilling, as well as inclination angle change intensity.

Then, in step (103), when the test well has been selected, the data obtained are used to create a combined geosteering model for rendering rock parameters and forecasting the wellbore position. In this step, it is necessary to propagate physical properties of the stratum (natural radioactivity, porousness, resistance) for a certain distance in the projected direction of the future well. For example, it is possible to round actual GK trace and to carry out TVD analysis of the model in the target interval.

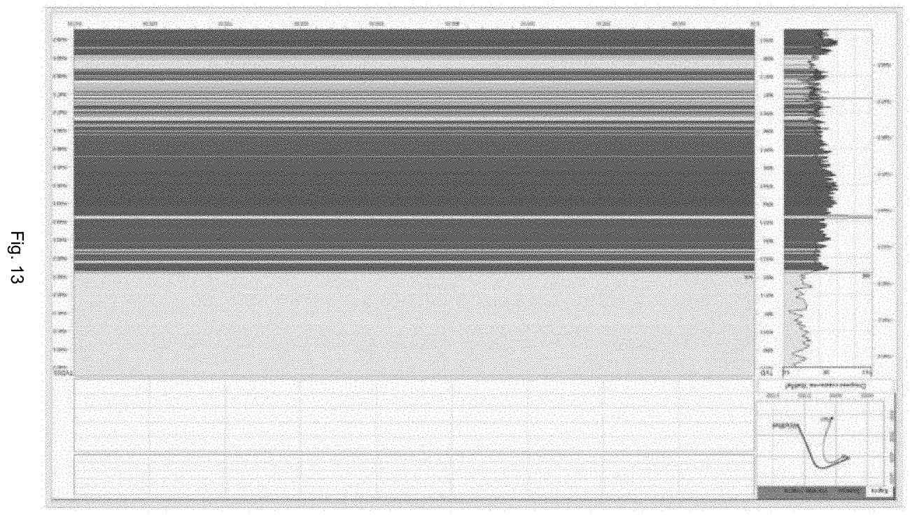

FIG. 12 shows an exemplary resulting combined model by propagating the properties of each point on the logging trace of the test well to the interval between 0 m and 1000 m by THL of the actual well.

Changing from mean logging to common logging, the model alters a bit, since additional (intermediate) values appear on the logging trace. Also, it will be necessary to understand which interlayers have to remain, in case the logging trace contains thousands of points, whereas the screen has resolution of 1024 lines (HD). To obtain accurate data, the following approach can be used: setting a specified TVD step and selecting a point on the GK trace with this step; assigning a specified color to the point and drawing another line of the geosteering model. This process is iteratively repeated along the entire TVD interval given, resulting in a model shown in FIG. 13.

Then, in step (104) determining at least one projected trajectory for well drilling based on test well(s) logging data. The projected trajectory is used in step (105) to plot a synthesized logging trace based on the combined model created.

Synthesized, or modelled, logging traces are obtained by transferring GIS data from previous wells to the trajectory of the future well. Such transfer takes into account stratigraphic structure of the field, presence of pinchouts and bellies in the stratum, as well as regional stratum dip angles.

Synthesized logging traces are calculated using the following algorithm:
a) Making use of the calculated trajectory of the actual well;
b) Setting the current point of the actual trajectory to be the starting point for calculations;
c) Selecting the current and next points;
d) Dividing the given interval based on the predetermined fixed step;
e) Selecting the first value of the divided interval as the current point;
f) Determining TVDSS in a given point for a given value, using linear interpolation along a linear trajectory;
g) Determining TVDSS shift relative to the coordinates origin, caused by dip angles;
h) If there is a curve in the resulting TVDSS, determining its value using an interpolator, otherwise, this value is assigned an invalid number;
i) If the end of the divided interval is reached, going to step (j); otherwise, the next value of the divided interval is set to be the current value, and the algorithm goes to step (f);
j) If the end of trajectory values is reached, returning the synthesized trace; otherwise, the next point becomes the current point, and the process continues from step (c).

Below is a more detailed description of the process of calculation of a synthesized logging trace.

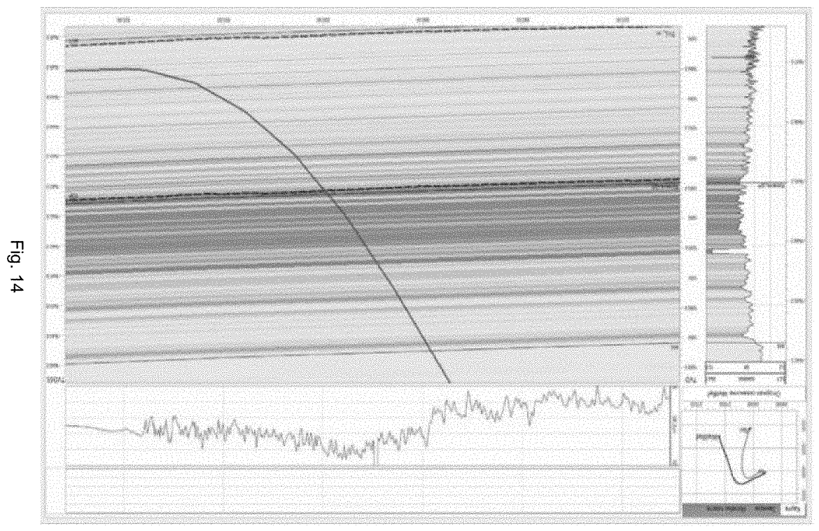

First, determining a trace for synthesized modelling (modelling of instrument readings with a given logging trace). FIG. 14 shows exemplary depiction of a selected logging trace on the TVD scale. For each point on the GK trace, it is necessary to put a point on the GK Syn trace (synthesized GK trace) relative to the THL scale. The artificial peak of 15 Gapi (orange interlayer) on the GK trace (vertical graph on the left) is matched with a peak on the synthesized trace in the THL point, where the orange interlayer is crossed by the projected trajectory of the future well.

The position of the peak on the synthesized trace depends on stratum dip angles, since the set of angles may affect the location of the point of intersection between the orange interlayer and the actual trajectory. The same calculations are carried out for all point pairs (GK, TVD) to obtain new point pairs (GK Syn, THL). When the stratum dip changes (e.g. when setting the model to a structural surface), the synthesized trace changes as well, since positions of points of intersections between strata and the trajectory will be different.

Therefore, a synthesized trace is a logging trace of the test well that has been converted from TVD into THL, with regard to the projected trajectory of the actual well and stratum dip angles in the geosteering model. The next step entails drilling and comparing actual logging trace with the synthesized one.

After synthesized traces for the geosteering model have been obtained, a geomechanical model (wellbore stability model) can be created in step 106, which is required to determine the projected trajectory in step 107. The ultimate goal is to obtain a projected trajectory that would be optimum in terms of both the target interval and wellbore stability.

To this end, the following steps are performed:
calculating lithostatic pressure and stratum pressure;
calculating mechanical properties of the rocks, and calculating formation and near-wellbore stresses; and
calculating wellbore stability.

Lithostatic pressure is calculated based on density along the cut, complemented with the following information:
1) Air column height in the location of the well mouth
2) Sea depth in the location of the well mouth

The calculations use the following formula:

P_{ovb}=∫₀^{z}ρ(z)gdz,

where z varies from 0 (well mouth) to TVD (Total Vertical Depth).

Normal rock compaction trend is calculated in four consecutive steps:
1) Marking (determining) clay intervals that presumably are at hydrostatic pressure;
2) Drawing a smooth line over the marked intervals on the acoustic logging and resistance logging traces;
3) Drawing a global line(s) of the trend across the areas found in steps 1 and 2;
4) Comparing the results with the calculations made in other wells of the same field to check them.

Clay intervals are marked by determining gamma-ray logging levels. All intervals, where the gamma-ray logging value is over the threshold value, are considered to be clay intervals. Smoothed values in the detected clay intervals are obtained through simple arithmetic averaging with sliding window.

There are many dependencies that can be used to calculate pore pressure based on logging data obtained while drilling. All and any dependencies have to be adjusted, i.e. checked for their performance in determining stratum pressure using wells that are already drilled, with direct measurements and other calibration data available. The following formulas are generally used:

Eaton equation (based on acoustic logging):

P_{Ds_Eaton}=P_{ovb}−(P_{ovb}−Pₙₒᵣₘ)×(ΔT_{compaction trend}/ΔT_{log})ⁿ

where
P_{ovb} is vertical stress,
Pₙₒᵣₘ is normal hydrostatic pressure,
ΔT_{compaction trend} is the interval time of pressure wave travel, corresponding to the normal compaction trend,
ΔT_{log} is the interval time of pressure wave travel according to LWD logging, and
n is adjustable Eaton's coefficient (3 for the Gulf of Mexico). It is calibrated on test wells using the data of actual measurements of the stratum pressure, as well as drilling events.

Eaton equation (based on resistance logging):

P_{res_Eaton}=P_{ovb}−(P_{ovb}−Pₙₒᵣₘ)×(R_{log}/R_{compaction trend})^{m}

where
P_{ovb} is vertical stress,
Pₙₒᵣₘ is normal hydrostatic pressure,
R_{compaction trend} is resistance corresponding to the normal compaction trend,
R_{log} is resistance according to logging, and
m is adjustable Eaton's coefficient (1.2 for the Gulf of Mexico). It is calibrated on test wells using the data of actual measurements of the stratum pressure, as well as drilling events.

Bowers equation (based on acoustic logging):

$${P}_{DT\_Bowers} = {P}_{ovb} - {( \frac{{V}_{log} - {V}_{0}}{A} )}^{1 / B}$$

where
P_{ovb} is vertical stress,
V_{log} is the pressure wave speed in logging,
V₀ is the speed in shallow depositions, and
A, B are Bowers' adjustable coefficients.

The formulas (1), (2), and (3) may be modified based on the fact that they utilize synthesized loggings created using GIS data from previous wells and the projected trajectory of the future well. Incorporating the formula for calculation of synthesized logging into formulas (1), (2), and (3), the following dependencies can be obtained:

1) Eaton equation for acoustic logging

Rock pressure=F (planned trajectory, acoustic logging of a test well, vertical stress, constant);

2) Eaton equation for resistance logging

Rock pressure=F (planned trajectory, resistance logging of a test well, vertical stress, constant);

3) Bowers equation

Pore resistance=F (planned trajectory, acoustic logging of a test well, vertical stress, constant).

In a situation when the drilling slot, which has been calculated as part of the geomechanical model for a given projected trajectory that is considered optimal in terms of the geosteering model, is too narrow and poses heightened risks for well drilling, it is necessary to modify the projected trajectory to provide for maximum drilling penetration within the target interval while keeping the wellbore stable.

After drilling has started (step 108), when a new batch of data (deviation survey data, logging data, drilling parameters) is obtained, the combined geomechanical and geosteering model is update (step 109). Below is the more detailed description of the process.

The geosteering component of the model can be changed based on newly obtained parameters.

After drilling has started and first actual GIS data have been obtained, geosteering is performed by modifying stratum geometry. The most frequent case is editing of stratum dip, wherein the angle is changed for a specific THL interval, but the change does not affect the synthesized calculations that happen in the left-hand side of the scale of horizontal deviation from the well mouth.

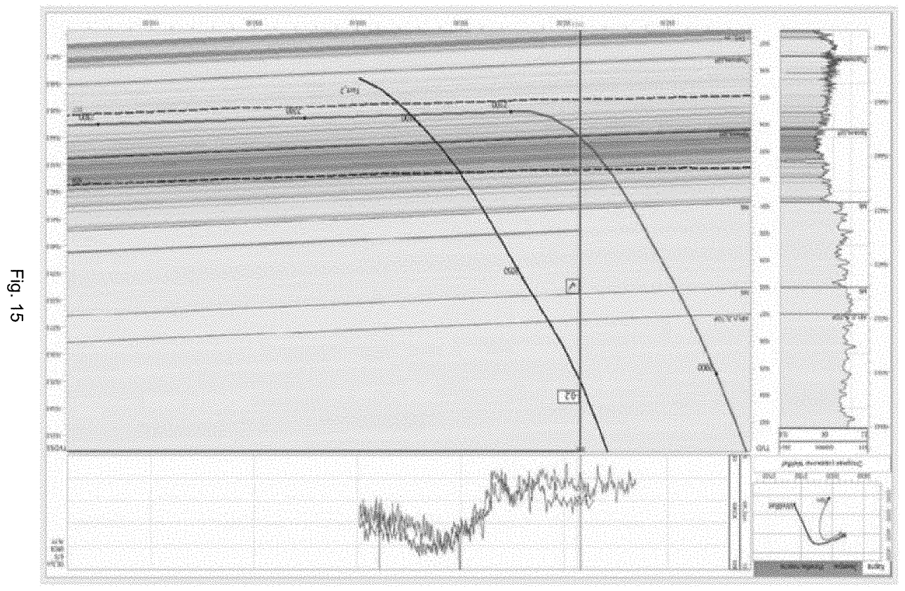

Returning to the previously created model: When additional logging data are obtained, e.g. a new pipe has been drilled, which adds 10 m to the GK logging trace. The synthesized calculations have to be set up for the logging data input. The original comparison is illustrated by FIG. 15.

To modify the shape of synthesized calculations, stratum dip has to be changed. Please note that the error margin of structural maps may amount to dozens of meters vertically, and therefore, the logging data for the well under construction should be given priority as a starting point in calculations.

FIG. 16 illustrates an example, where the stratum dip is increased to 0.3 degree, and the inclination angle of 0.6 degree is added at the THL point of 937 m. This example shows that there is a certain discrepancy between actual and synthesized logging traces in the THL interval of 937-1007 m. Changing the angle from 0.6 degree to 0.9 degree, the synthetic trace coincides with the actual trace. This shows the determination of the wellbore position in the stratum for the given THL interval. Below, the interval containing the wellbore at the moment will be discussed.

The example shows that in the interval between 937 m and 1007 m by THL, GK trace goes up, which means that the wellbore is approaching clay interlayers, and it is necessary to direct the activities of the drilling team so that the well does not go outside the target interval. As the data are updated, the synthesized trace is set up to the actual trace, wherein the stratum dip is changed in THL points. After the required coincidence between the modelled and actual logging has been achieved for the new THL interval, the drilling guidelines for the next interval are generated.

Upon receiving real-time logging data (gamma-ray logging, density logging, acoustic logging), the stratum elasticity and strength properties are automatically recalculated; stratum stress calculations are also updated, depending on the current trajectory and other parameters. Caliper survey data obtained during drilling allow to assess how well the stability model describes the current situation.

In case there is discrepancy between the modelled and actual behavior of the well, its reasons are analyzed and the model is adjusted. In addition to caliper survey data, the following parameters can describe the state of the wellbore: deviation from/conformance to the trends of mud weight increase with depth, moment behavior, surface and annular pressure. Besides, sludge analysis can provide first-hand information about what is going on in the well.

For example, angular debris hint at cavings, whereas long flat plates hint at depression drilling. At the same time, the level of fluid in reservoirs is closely monitored to detect inrushes or mud absorption. All this information is taken into account when updating the calculations of stability of the opened-up interval to improve the predictability of the model used to formulate guidelines for drilling of further strata.

After the combined model has been updated, a search for an optimum trajectory is conducted. The trajectory of drilling within the next interval has to stay inside the target stratum (geosteering model limitation), but at the same time is has to minimize drilling risks (geomechanics limitation). Each change in the projected trajectory leads to cascading changes and repeat calculations in the wellbore stability model.

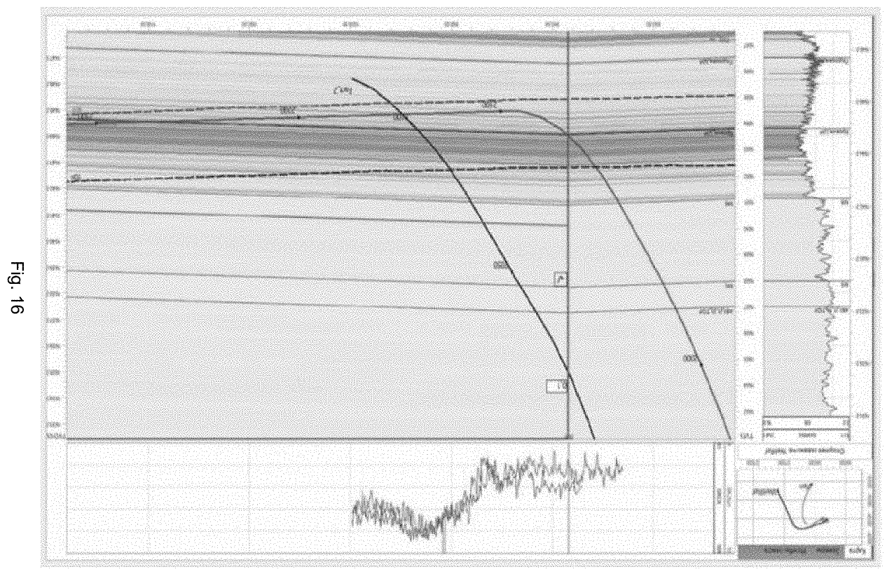

FIG. 17 shows an exemplary calculation of mechanical properties and stresses. The main input comprises:
The projected trajectory of the well;
Synthesized logging data; and
Discrete facie curve (optional).

Dynamic elastic modules (stiffness and Poisson's ratio) are calculated using the following formulas:

$${E}_{dy n} = ρ {V}_{s}^{2} \frac{3 {V}_{p}^{2} - 4 {V}_{s}^{2}}{{V}_{p}^{2} - {V}_{s}^{2}}$$

$${v}_{dy n} = \frac{{V}_{p}^{2} - 2 {V}_{s}^{2}}{2 ( {V}_{p}^{2} - {V}_{s}^{2} )}$$

where
ρ is stratum logging,
Vₚ,Vₛ, are the pressure and shear wave speeds in acoustic logging.

Given that static elastic parameters do better describe the rock behavior during drilling and correlate well with the dynamic properties that have been determined based on logging, the correlations that have been determined for the given field or region will be used.

Parameters of strength, such as uniaxial compression strength, angle of internal friction, tensile limit, are calculated based on correlations with various environmental parameters, including clay content, porousness, thickness, etc. They are calculated separately for each region.

Far horizontal stresses are calculated based on the poroelastic medium equation.

Stresses always depend on the specific well trajectory, particularly, its vertical:

σₕ−αρ=ν(σ_{ν}−αρ)+{Ε/(1−ν²)}εₕεₕ+{Εν/(1−ν²)}ε_{H}

σ_{H}−αρ=ν(σ_{ν}−αρ)+{Ε/(1−ν²)}εₕε_{H}+{Εν/(1−ν²)}εₕ

where
α is the Biot coefficient,
p is stratum pressure,
ν is the Poisson's ratio,
Ε is stiffness of the medium,
ε_{H} are tectonic deformations characteristic for a region or formation.

Biot coefficient describes how effectively fluid pressure resists an applied load. Is basically equals 1 for depositions containing tough rocks, though at depths of more than 4 km, it may be less than 1; which is calculated based on porousness logging.

Given that during drilling, rock formation is replaced with a fluid column, existing stresses are redistributed, and some new stresses appear, such as radial stress, axial stress, and tangential stress. Near-wellbore stresses are a direct function of distant stratum stresses, as well as of how near the point of measurement is to the well, the location of well itself, and its azimuthal position relative to the impact direction of the maximum horizontal stress. The calculation of near-wellbore stresses for the well, whose trajectory goes along one of the main stresses) looks as follows [Kirsh]:

$${σ}_{\text{?}} = \frac{1}{2} ( {σ}_{\text{?}} + {σ}_{\text{?}} ) ( 1 - \frac{{R}_{\text{?}}^{2}}{{r}^{2}} ) + \frac{1}{2} ( {σ}_{\text{?}} - {σ}_{\text{?}} ) ( 1 + \frac{3 {R}_{w}^{4}}{{r}^{4}} - \frac{4 {R}_{w}^{2}}{{r}^{2}} ) cos 2 ϑ + {p}_{\text{?}} \frac{{R}_{w}^{2}}{{r}^{2}}$$

$${σ}_{\text{?}} = \frac{1}{2} ( {σ}_{\text{?}} + {σ}_{\text{?}} ) ( 1 + \frac{{R}_{w}^{2}}{{r}^{2}} ) - \frac{1}{2} ( {σ}_{\text{?}} - {σ}_{\text{?}} ) ( 1 + \frac{3 {R}_{w}^{4}}{{r}^{4}} ) cos 2 ϑ - {p}_{\text{?}} \frac{{R}_{w}^{2}}{{r}^{2}}$$

$${σ}_{\text{?}} = {σ}_{\text{?}} - 2 v ( {σ}_{HMAX} - {σ}_{\text{?}} ) \frac{{R}_{w}^{2}}{{r}^{2}} cos 2 ϑ$$

$${τ}_{\text{?}} = - \frac{1}{2} ( {σ}_{HMAX} - {σ}_{\text{?}} ) ( 1 - \frac{3 {R}_{w}^{4}}{{r}^{4}} + \frac{2 {R}_{w}^{2}}{{r}^{2}} ) sin 2 ϑ$$

$${τ}_{\text{?}} = {τ}_{\text{?}} = 0$$

$$\text{?} \text{indicates text missing or illegible when filed}$$

σᵣ is radial near-wellbore stress,
σ_{θ} is tangential near-wellbore stress,
σ_{z} is axial near-wellbore stress,
T_{rθ}, T_{θz}, T_{rz} are near-wellbore shear stress in various directions,
σₕₘᵢₙ σ_{Hmax} are distant horizontal stratum stresses,
v is the Poisson's ratio,
r, R_{w} is radial direction, or well radius, and
θ is the angle to the impact direction of the maximum horizontal pressure.
Near-wellbore stresses have direct impact on whether the wellbore caves in or not.

Essentially, the wellbore stability analysis consists in the following: in points where stress concentration is higher than the rock strength, cavings occur; in points where stresses are so low that they turn into tensile stresses (negative stresses, mathematically speaking), cracks form. As a rule, the Mohr-Coulomb failure criterion is used. This failure criterion allows to obtain the ratio between two main stresses at the moment of rock destruction. This failure criterion is not limited to certain stress directions, so it may be used for reservoirs that are either under tension or under compression. It is assumed that vertical stress is one of the main stresses.

Thus, instability and risks of oil, gas and water showings or mud absorption can be presented as a function of the following parameters:

Caving formation=F (well trajectory, distant stratum stresses, stratum pressure, near-wellbore stresses, well pressure, compression strength of the formation, Poisson's ratio);

Oil, gas and water showings=F (well trajectory, stratum pressure, well pressure, formation permeability);

Absorptions and fracking crack generation=F (well trajectory, stratum and near-wellbore stresses, stratum pressure, well pressure, tensile strength of the formation).

This set of algorithms produces a calculation of the minimum pressure required to prevent the wellbore from caving in and of the maximum pressure to prevent fracking. Calculated pressure curves allow to determine the mud weight window, as well as detect intervals of instability and possible circulation failures.

The model provides four basic values:
Pore pressure gradient;
Absorption start gradient;
Caving gradient;
Fracking gradient.

This is the final step in geomechanical calculations, comprising the results obtained in all previous steps that have been described above. Wellbore stability calculations provide engineers with detailed understanding of stress distribution around the wellbore. Based on the calculations, it is possible to determine the optimum mud weight window and instability intervals, along with the best azimuth and well inclination angle in the most unstable strata, as well as optimize the drive-pipe scheme.

By utilizing the results of geomechanical calculations, it is possible to level the negative factors linked with drilling through areas with abnormal seam pressure or low fracking gradient, low wellbore stability, strata subsidence, induced seismic activity, penetrating crack-riddled reservoirs, sand failures while drilling.

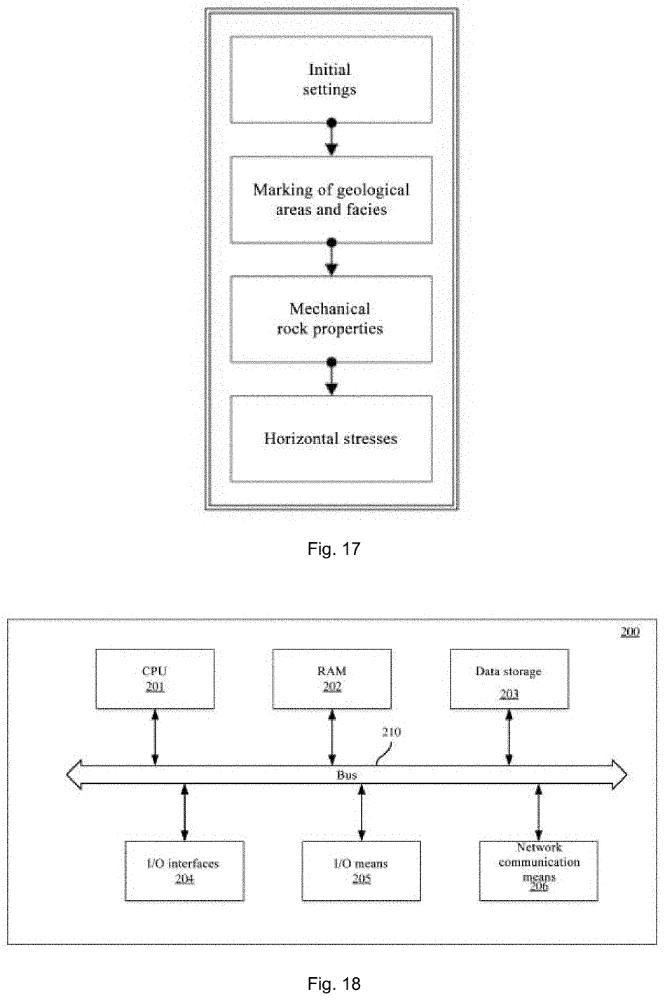

FIG. 18 shows an overall view of the system (200) to perform the claimed method. Generally, the system 200 may be also represented by a computing device, e.g. a PC, laptop, server, mainframe, smartphone, tablet, etc.

The system (200) comprises one or more CPUs (201) that process the data as described; RAM (202) that stores machine-readable instructions to be executed by the CPU in order to implement the claimed method (100); and permanent storage means (203) which may include, e.g. hard disk drive (HDD), solid-state drive (SSD), flash memory drive, optical disks (CD, DVD, Blu-ray), etc.

The system (200) also comprises a set of interfaces (204) for connecting various devices, such as. USB, USB type C, Micro-USB, PS/2, COM, LPT, FireWire, Lightning, Jack-audio, etc.

I/O devices 205 may include: a keyboard, speakers, a display, a sensor display, a trackball, a mouse, a light pen, a stylus, a touchpad, a projector, a joystick, a voice recognition interface, a neuroset, etc.

Network communication means (206) enable receiving and sending information over network protocols. These means (206) may include an Ethernet card, Wi-Fi module, NFC module, IrDa, Bluetooth, BLE, satellite communications module, etc. The means (206) are used to transfer data over the Internet, Intranet, LAN, etc.

The system (200) may receive data for geosteering from multiple external sources and may be represented by a cloud-based server to compute logging data based on synthesized calculations. The data may be sent to the system (200) via either the WITSML (Wellsite Information Transfer Standard Markup Language) protocol or a mail server. Currently, WITSML is the most common format for transferring wellsite data in the oil-and-gas sphere, which has been developed by Energistics. The company deals now with almost all domains concerning oil and gas productions, from petrophysics and geophysics through drilling assets management to exploration and drilling. The main reason for developing this language was to try to get a continuous information flow between the operator and service providers in order to reduce the downtime when making well-drilling-related decisions. Internet communications allow to provide remote steering of well drilling, regardless of the actual distance between the wellsite and geologists.

The present disclosure of the claimed solution describes its preferred embodiments, without limiting its scope, and including, by extension any other exemplary embodiments, which fall under the claims and may be considered obvious by those skilled in the art.

What is claimed is:

1. A method of combined support for a well drilling process, comprising the steps of:
receiving input data of the well which is being developed, including at least inclinometry data, well logging data and core data;
obtaining logging data of at least one reference well;
forming, on a basis of the mentioned input data and the logging data of at least one reference well, a combined model displaying rock characteristics and predicting a position of the well which is being developed;
determining at least one planned trajectory of a direction of drilling the well which is being developed; the trajectory being based on the logging data of at least one reference well;
calculating at least one synthetic logging curve based on the aforementioned combined model and at least one planned trajectory of the well which is being developed;
performing a construction of a preliminary model of a stability of a wellbore, based on at least one trajectory of the well which is being developed and calculated at least one synthetic curve;
determining, based on the preliminary model of the wellbore stability, an updated planned trajectory that ensures maximum of a well penetration within a target interval and the wellbore stability;
receiving parameters during a drilling of the well which is being developed; the parameters related to the inclinometry, logging data and the drilling;
updating the mentioned combined model and controlling a process of the well drilling based on the updated combined model.

2. The method according to claim 1, wherein during the process of the well drilling, the stability of the wellbore is recalculated based on the obtained drilling parameters.

3. The method according to claim 2, wherein the method additionally uses information about a presence of cracks in a reservoir.

4. The method according to claim 1, wherein when updating the combined model, a position of the developed well within a target formation is checked.

5. The method according to claim 1, wherein a selection of the reference well is carried out due to a cross-hole correlation and structural maps on a roof of a target formation.

6. The method according to claim 1, wherein the preliminary model of the wellbore stability is based on parameters of a reservoir pressure, a hydraulic fracturing gradient, mechanical properties of a rock and stresses.

7. A system for combined tracking of a well drilling process, comprising: at least one processor and at least one memory means storing machine-readable instructions that, when executed by the processor, implement the method according to any one of claims 1-6.
